(19) United States
(12) Patent Application Publication
(10) Pub. No.: US 2006/0215397 A1
(43) Pub. Date: Sep. 28, 2006

(54) Lamp structure with a function of candlestick

(75) Inventor: Kevin Lee, Taipei (TW)

Correspondence Address: Lipan Industrial Co., Ltd., P.O. Box No. 6-57, Junghe, Taipei, 235, TW

(73) Assignee: Lipan Industrial Co., Ltd., Taipei (TW)

(21) Appl. No.: 11/088,724

(22) Filed: Mar. 25, 2005

(51) Int. Cl. F21V 33/00; F21V 35/00

(52) U.S. Cl. 362/161; 362/101

(57) ABSTRACT

A lamp structure with a function of candlestick primarily includes a lamp seat, a light source located at a top of the lamp seat, and both a battery chamber provides both a DC power source and an AC power source, enabling the provision of power source to the light source through a conventional AC, DC power source. A liquid containing transparent or reflective floating objects is filled in the transparent shade which is covered on a periphery at a top of the light source. A candlestick in a dish shape is located at a top of the transparent shade, for holding a candle. A visual effect of dynamic change is created to the floating objects by a projection of light into the transparent shade from the light source, and by heating up the liquid in the transparent shade from the light source, thereby increasing the interest in application.

### BACKGROUND OF THE INVENTION

(a) Field of the Invention

The present invention relates to a lamp structure with a function of candlestick, and more particularly to a lamp structure also having a candle as an auxiliary light source.

(b) Description of the Prior Art

In old days, a candle is used conventionally as lightening equipment for a primary light source. However, as time advances, candles of insufficient brightness have been gradually replaced by light bulbs, and turned into a tool representing romance. In addition, candles can also be used as an auxiliary light source in a circumstance without a power source.

For a conventional lamp structure, although there are different structural designs according to the variation of structure of the light bulbs (light source), most of the structures basically consist of a casing with a lamp seat for holding related wires (and circuit boards), along with a transparent shade which can be assembled with the lamp seat, so as to assemble a light bulb with the lamp seat, to enlighten after electrically conducting the light bulb, and to emit the light outward through the transparent shade, thereby achieving the basic function of lightening. Most of the lamp products in the current market have the aforementioned basic structure, with differences in the design of appearance for attracting consumers.

However, the design of the aforementioned lamp structure is only for a single light source (light bulb). Therefore, the lamp structure cannot be used in a circumstance without a power source, which is one of the limitations in application. In addition, light generated from a light bulb source does not easily replace that from a conventional candle for creating a romantic mood. Accordingly, how to use a simple structure for providing a convenience of light bulbs and a lightening function in the circumstance without a power source has become an issue to be solved by related industries.

### SUMMARY OF THE INVENTION

The primary object of the present invention is to provide a lamp structure with a function of candlestick, which comprises primarily a lamp seat and a light source (light bulb) installed on the seat, with a transparent shade covered on a periphery at a top of the light source. A liquid containing transparent or reflective floating objects or other dynamic devices with changeable colors is filled in the transparent shade. A candlestick of a dish shape is at a top of the transparent shade for holding a candle. Light is projected into the transparent shade by the light source, and in the same time a heat generated by the light source is used to heat up the liquid in the transparent shade, creating a visual effect of dynamic change to the floating objects, thereby increasing the interest of application.

Another object of the present invention is to install at the same time a battery chamber for providing a DC power, and an adapter device for providing an AC power, so as to apply to a conventional AC, DC power at the same time, thereby increasing the convenience in application.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an assembly view of a structure of the present invention.

FIG. 2 shows a schematic view and an implementation drawing of a candlestick of the present invention.

FIG. 3 shows a schematic view of a transparent shade of a first implementation of the present invention.

FIG. 4 shows a schematic view of a transparent shade of a second implementation of the present invention.

FIG. 5 shows a schematic view of a transparent shade of a third implementation of the present invention.

FIG. 6 shows a schematic view of a transparent shade of a fourth implementation of the present invention.

FIG. 7 shows a schematic view of a transparent shade of a fifth implementation of the present invention.

### DETAILED DESCRIPTION OF THE PREFERRED EMBODIMENTS

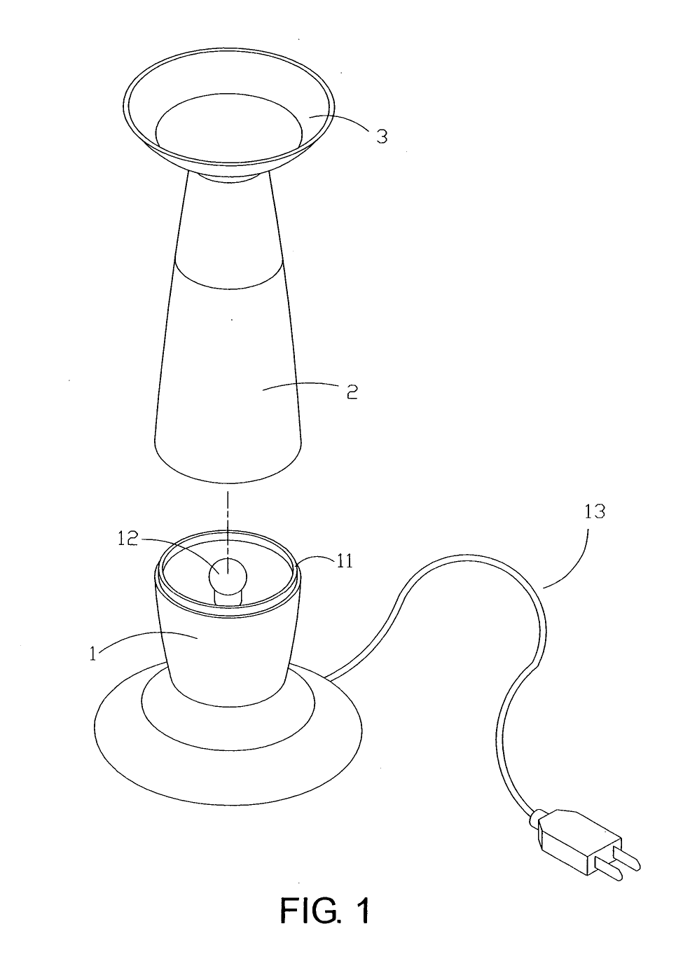

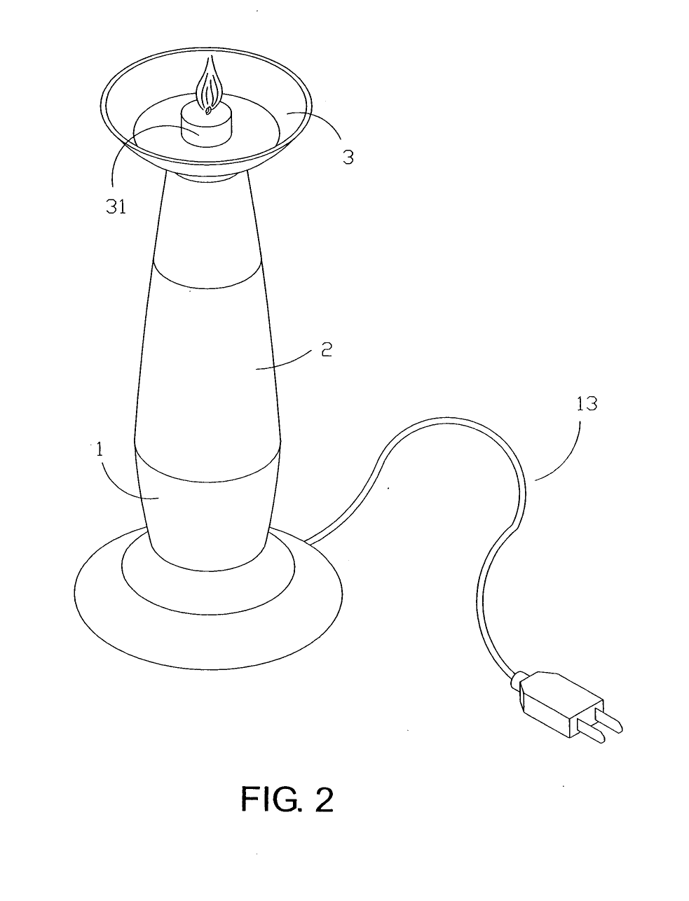

Referring to FIG. 1 and FIG. 2, the present invention comprises primarily a lamp seat 1, a transparent shade 2, and a candlestick 3, wherein a light source 12 (light bulb) is located at a top side of the lamp seat 1, and a ring of flange 11 is located at a periphery of the light source 12. Both an AC adapter device connected with a power cord 13 and a battery chamber for holding batteries for providing a DC power source are located in the lamp seat 1, so as to provide the necessary AC, DC power sources for the light source 12. The transparent shade 2 is made of a (colored or colorless) transparent material 10 and is a hollow structure with an opening at one end. A ring of groove corresponding to the ring of flange 11 of the lamp seat 11 is located at a periphery of the opening of the transparent shade 2, thus enabling the formation of a sealing by covering the transparent shape 2 on the top of the lamp seat 1. The candlestick 3 is a dish shape body located at a top of the transparent shade 2. When the lamp seat 1 is directly connected to an AC power source, or batteries are inserted into the battery chamber in the lamp seat 1, the light source 12 (light bulb) is turned on and emits light which can be emitted outward through the transparent shade 2. A variation of light can be generated according to a colored or colorless structure of the transparent shade 2. A candle 31 can be held at a top of the candlestick 3, so as to generate light upon burning the candle, and to directly emit light outward from the top of the candlestick 3.

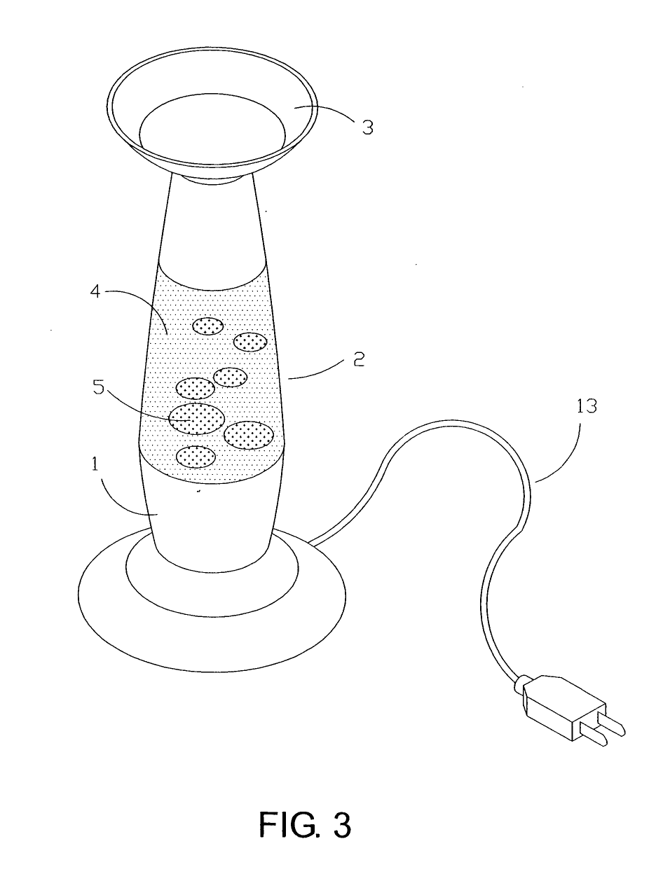

Referring to FIG. 3, it shows a schematic view of a first implementation of the transparent shade of the present invention. A colored liquid 4 containing a plurality of floating waxes 5 is filled in the transparent shade 2. By using a heat generated from the enlightening of the light source 12, convection is created in the colored liquid 4 in the transparent shade 2, and the waxes 5 are also floating accordingly, so as to display a dynamic effect of transparency, and to form a visual effect of gently floating transparent objects in the transparent shade 2.

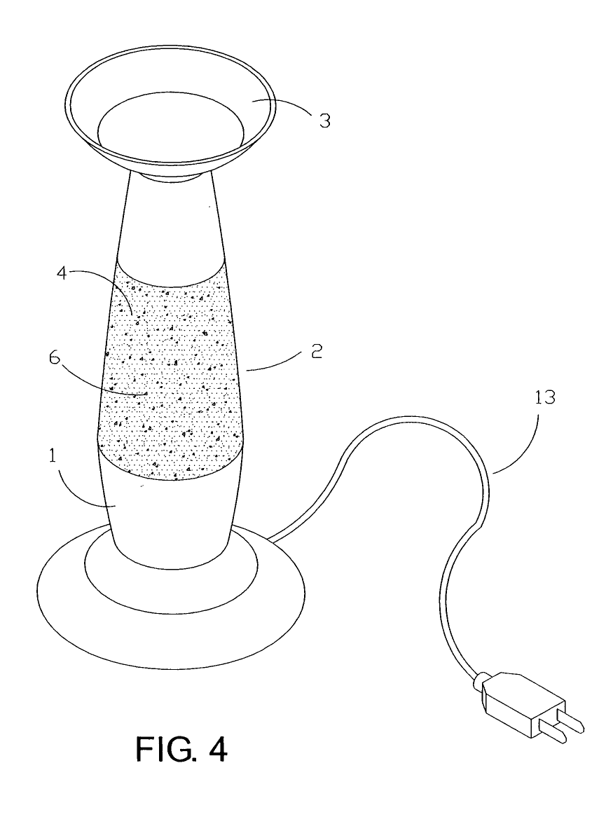

Referring to FIG. 4, it shows a schematic view of a second implementation of the transparent shade of the present invention. A colored liquid 4 containing a dispersion of a plurality of reflective spangles 6 is filled in the transparent shade 2. By using a heat generated from the enlightening of the light source 12, convection is created in the colored liquid 4 in the transparent shade 2, and the reflective spangles 6 are also floating accordingly, so as to display a dynamic effect of reflection, and to form a visual effect of sparkling light dots in the transparent shade 2.

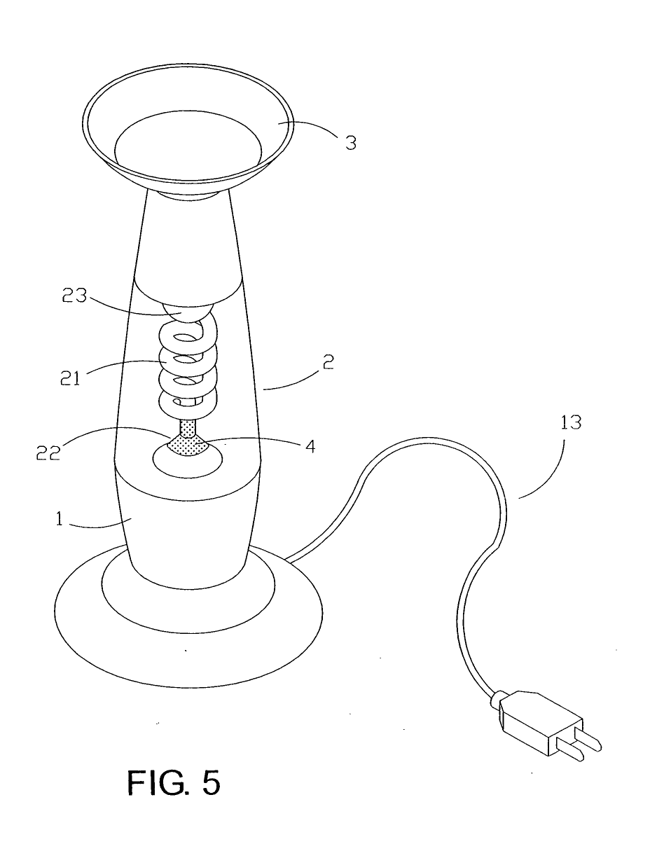

Referring to FIG. 5, it shows a schematic view of a third implementation of the transparent shade of the present invention. A vertical transparent spiral tube 21 is located in the transparent shade 2 with a lower container 22 and an upper container 23 at a bottom and a top side of the spiral tube 21, respectively. A proper amount of colored liquid 4 is contained in the lower container 22 which is just located at a top of the light source 12. By using a heat generated from the enlightening of the light source 12 to heat up the lower container 22, the colored liquid 4 in the lower container 22 is swollen and gliding upward to the upper container 23 along the transparent spiral tube 21. After turning off and cooling off the light source 12, the colored liquid 4 can glide down spirally to the lower container 22 from the upper container 23, thereby forming a visually changing effect of spirally rotating.

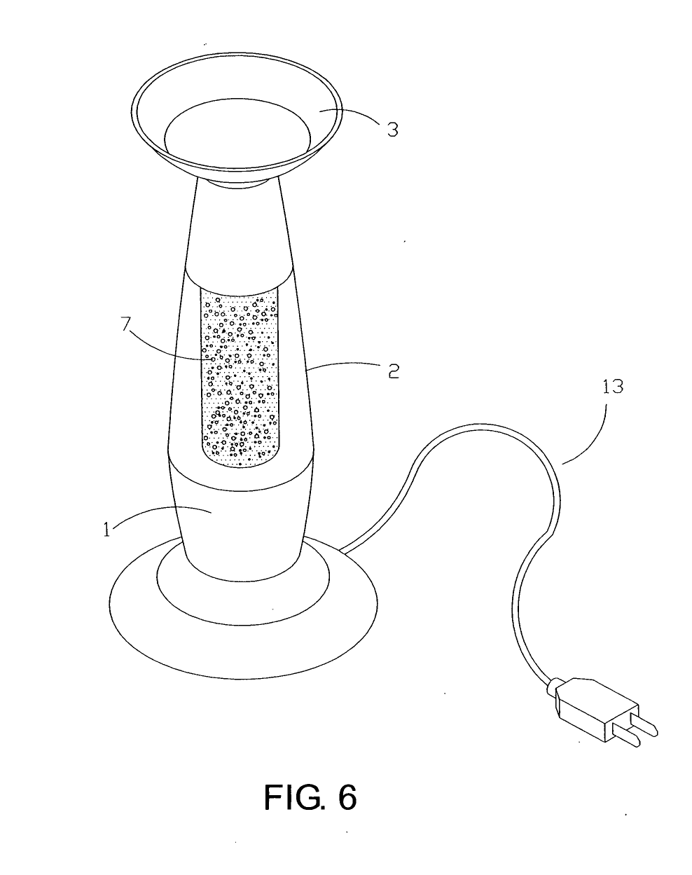

Referring to FIG. 6, it shows a schematic view of a fourth implementation of the transparent shade of the present invention. A (transparent or colored) liquid is filled in the transparent shade 2, and a bubbling device is located at a bottom of the transparent shade 2 for sucking an outside air into the transparent shade 2. Therefore, the liquid in the transparent shade 2 is filled with bubbles 7, and another visual effect of sparkling light dots can be formed in the transparent shade 2 using a reflection and refraction effect of the bubbles 7 themselves.

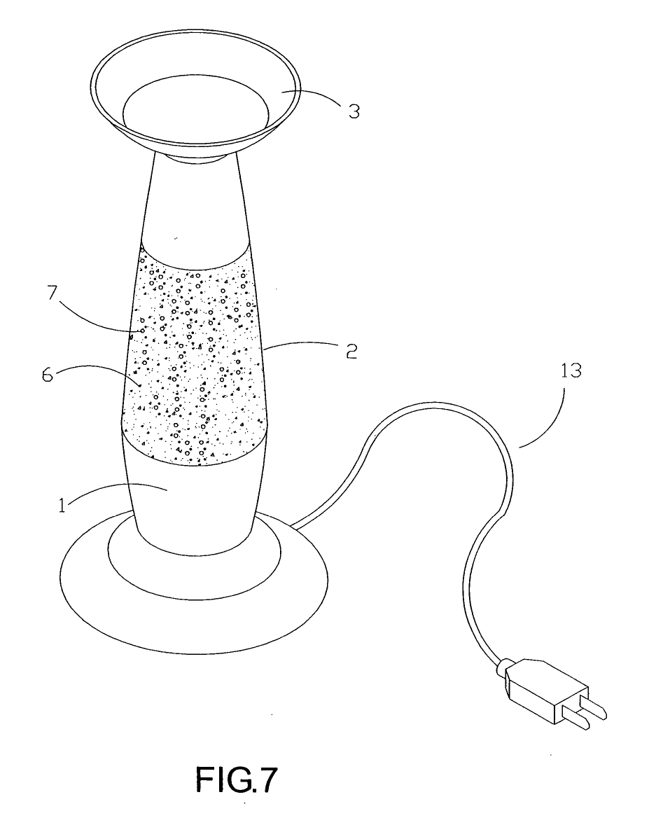

Referring to FIG. 7, it shows a schematic view of a fifth implementation of the transparent shade of the present invention. Other than that a (transparent or colored),liquid is filled in the transparent shade 2, a bubbling device is also located at a bottom of the transparent shade 2 for sucking an outside air into the transparent shade 2. Therefore, the liquid in the transparent shade 2 is filled with the bubbles 7, and a plurality of floating reflective spangles 6 are also dispersed in the transparent shade 2, forming a visual effect of versatilely sparkling light dots in the transparent shade 2 using a different reflection and refraction effect between the bubbles 7 and the reflective spangles 6.

Accordingly, the present invention truly has a function of lightening with a candle and a visual effect of dynamic change, and thus is indeed equipped with industrial applicability, originality, and advancement.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A lamp structure with a function of candlestick including at least a lamp seat whose top side is located a light source capable of receiving electric energy and emitting light; a transparent shade made of a transparent material, being a hollow structure with an opening at one end, filled with a transparent liquid, with the opening of the transparent shade covered on a periphery of the light source, and both a battery chamber and an AC adapter device connected with a power cord located in the lamp seat; a candlestick located at a top of the aforementioned transparent shade for holding at least one candle.

2. The lamp structure with a function of candlestick according to claim 1, wherein a plurality of floating and transparent waxes and reflective spangles are contained in the liquid in the transparent shade.

3. The lamp structure with a function of candlestick according to claim 1, wherein a vertical transparent spiral tube is located in the transparent shade, with a lower and an upper container located at a bottom and a top of the transparent spiral tube, respectively, and a proper amount of colored liquid is contained in the lower container.

4. The lamp structure with a function of candlestick according to claim 2, wherein a vertical transparent spiral tube is located in the transparent shade, with a lower and an upper container located at a bottom and a top of the transparent spiral tube, respectively, and a proper amount of colored liquid is contained in the lower container.

5. The lamp structure with a function of candlestick according to claim 1, wherein a bubbling device is located at a bottom of the transparent shade, enabling the bubbles to be filled in a liquid in the transparent shade.

6. The lamp structure with a function of candlestick according to claim 2, wherein a bubbling device is located at a bottom of the transparent shade, enabling the bubbles to be filled in a liquid in the transparent shade.
